(19) United States
(12) Patent Application Publication
(10) Pub. No.: US 2014/0116398 A1
(43) Pub. Date: May 1, 2014

(54) FUEL PUMP MODULE

(71) Applicant: COAVIS, Yeongi-gun (KR)

(72) Inventors: Mun Sik JEON, Cheongju-si (KR); Jin Sik HWANG, Yeongi-gun (KR); Joon Seup KIM, Daejeon (KR)

(73) Assignee: COAVIS, Yeongi-gun (KR)

(21) Appl. No.: 13/967,454

(22) Filed: Aug. 15, 2013

(30) Foreign Application Priority Data
Oct. 31, 2012 (KR) 10-2012-0121737

(51) Int. Cl. F02M 37/00

(52) U.S. Cl. CPC F02M 37/0011
USPC 123/509

(57) ABSTRACT

Provided is a fuel pump module capable of preventing the static electricity from being accumulated on a fuel pump module, and thus preventing firing and explosion, by forming lines from a pump mounting portion on which a fuel pump is mounted to a inlet port of a flange assembly with electrically conductive material and connecting them to a connector formed on the flange assembly with a ground lead line, so that the static electricity generated by the friction caused by the flow of the fuel is discharged to the outside of the fuel pump module, i.e., the chassis of a vehicle.

### CROSS-REFERENCE TO RELATED APPLICATIONS

This application claims priority under 35 U.S.C. §119 to Korean Patent Application No. 10-2012-0121737 filed on Oct. 31, 2012, in the Korean Intellectual Property Office, the disclosure of which is incorporated herein by reference in its entirety.

### TECHNICAL FIELD

The following disclosure relates to a fuel pump module, and in particular, to a fuel pump module, which is mounted in a fuel tank of a vehicle to suck and pump fuel to an engine, capable of preventing static electricity from being accumulated thereon, thereby preventing firing and explosion due to the accumulated static electricity.

### BACKGROUND

In general, vehicles, which are driven by liquid fuel such as gasoline engine or diesel engine vehicles, include fuel tanks storing fuel. A fuel tank includes a fuel pump module, which is connected to an engine via a fuel feed line to feed the fuel stored in the fuel tank to the engine.

A fuel pump module includes a flange assembly fixed to a fuel tank and having a inlet port for feeding fuel to an engine, a guide rod extending from the lower side of the flange assembly, a reservoir body having a void section on its lower surface via which fuel flows in, a pump mounting portion coupled with the upper side of the reservoir body, and a fuel pump fixed on the pump mounting portion in the reservoir body to suck the fuel in the reservoir body and pump out the fuel to the engine.

Further, the pump mounting portion has a fuel outlet hole via which the fuel pumped out is ejected, and is connected to a connection port formed on the lower side of the flange assembly via a fuel pump tube. The connection port communicates with the inlet port formed on the upper side of the flange assembly, and the inlet port is connected to the engine via a fuel feed line.

However, the fuel pump module thus configured has a shortcoming in that static electricity may be accumulated on the fuel pump module due to friction with fuel or the like, such that sparks may occur to cause firing and explosion of fuel.

In particular, since static electricity is generated due to the friction caused by the flow of fuel pumped out under high pressure along the lines from the fuel pump to the inlet port of the flange assembly, it is necessary to provide a fuel pump module capable of preventing static electricity from being accumulated.

In this regard, Japanese Patent Laid-Open Publication No. 2011-088563 discloses “Fuel Tank.”

### RELATED ART DOCUMENT

### Patent Document

(Patent Document 1) Japanese Patent Laid-Open Publication No. 2011-088563 (May 6, 2011).

### SUMMARY

An embodiment of the present invention is directed to providing a fuel pump module capable of preventing the static electricity from being accumulated on a fuel pump module, and thus preventing firing and explosion, by forming lines from a pump mounting portion on which a fuel pump is mounted to a inlet port of a flange assembly with electrically conductive material and connecting them to a connector formed on the flange assembly with a ground lead line, so that the static electricity generated by the friction caused by the flow of the fuel is discharged to the outside of the fuel pump module, i.e., the chassis of a vehicle.

In one general aspect, a fuel pump module according to an embodiment of the present invention includes: a flange assembly 100 in which a supplying port 120 is formed at one side of a flange 110 and an insert port 130 connected to the supplying port 120 is formed at the other side; a guide rod 200 extending from the flange assembly 100; a reservoir body 300 coupled with the guide rod 200 and having a fuel pump 310 therein; a pump mounting portion 400 coupled with the reservoir body 300, fixing the fuel pump 310, and having a fuel outlet hole 410 via which fuel pumped by the fuel pump 310 is ejected; and a fuel pump tube 500 connecting the insert port 130 and the fuel outlet hole 410, wherein one side of the insert port 130 is coupled inside the supplying port 120, and the other side of the insert port 130 is connected to the fuel pump tube 500, and wherein the insert port 130, the pump mounting portion 400 and the fuel pump tube 500 are made of electrically conductive material, so that the pump mounting portion 400 is electrically connected to a connector 140 formed on the flange assembly 100 by a ground lead line 600.

The inlet port 120 may be extended from the upper side of the flange 110 and bent toward one side, and one side of the insert port 130 is coupled with the inner side of the inlet port 120. The insert port 130 may be coupled to include the bent portion of the inlet port 120.

The other side of the insert port 130 may be formed with a slope with respect to the normal direction of the surface of the flange 110.

The horizontal portion 122 of the supplying port 120 may be extended from one side of a protruding portion 123 protruding upwardly of the flange 110, and a recessed hollow portion 124 may be formed at the lower side of the protruding portion 123, such that one side of the insert port 130 may be coupled with the protruding portion 123 of the supplying port 120, and the other side of the insert port 130 may be located at the recessed hollow portion 124.

One side of the insert port 130 may be coupled with a part of the horizontal portion 122 of the supplying port 120 and the protruding portion 123, and the other side of the insert port 130 may be located at the recessed hollow portion 124.

The other side of the insert port 130 may be formed with a slope with respect to the normal direction of the surface of the flange 110.

The insert port 130 may be formed integrally with the flange 110 and the supplying port 120 by insert injection molding.

Other features and aspects will be apparent from the following detailed description, the drawings, and the claims.

### BRIEF DESCRIPTION OF THE DRAWINGS

FIG. 1 is a cross-sectional view of a fuel pump module according to an embodiment of the present invention;

FIGS. 2 to 4 are partial cross-sectional views of flange assemblies according to various embodiments of the present invention;

FIG. 5 is a cross-sectional view of a fuel pump module according to another embodiment of the present invention; and

FIG. 6 is a perspective view showing an upper side of a flange assembly of the fuel pump module according to another embodiment of the present invention.

[Detailed Description of Main Elements]

| | |
|---|---|
| 1000: fuel pump module | |
| 100: flange assembly | |
| 110: flange | |
| 120: inlet port | |
| 121: vertical portion | 122: horizontal portion |
| 123: protruding portion | 124: recessed hollow portion |
| 130: insert port | |
| 131: vertical portion | 132: horizontal portion |
| 140: connector | |
| 200: guide rod | 210: elastic means |
| 300: reservoir body | 310: fuel pump |
| 400: pump mounting portion | 410: fuel outlet hole |
| 500: fuel pump tube | |
| 600: ground lead line | |

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, fuel pump modules according to embodiments of the present invention as described above will be described in detail with reference to the accompanying drawings.

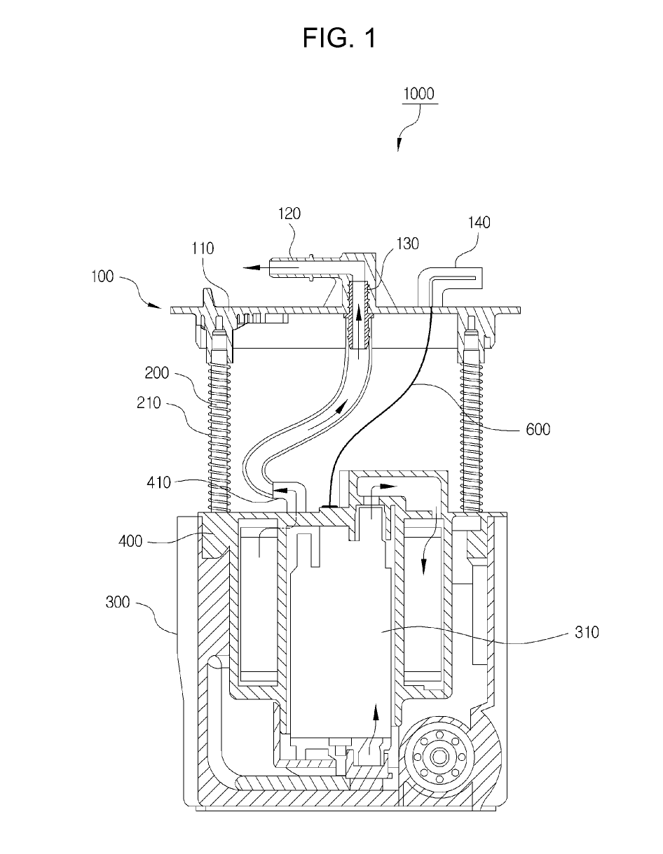

FIG. 1 is a cross-sectional view of a fuel pump module according to an embodiment of the present invention.

As shown, a fuel pump module 1000 according to an embodiment of the present invention includes: a flange assembly 100 in which a inlet port 120 is formed at one side of a flange 110 and an insert port 130 connected to the inlet port 120 is formed at the other side; a guide rod 200 extending from the flange assembly 100; a reservoir body 300 coupled with the guide rod 200 and having a fuel pump 310 therein; a pump mounting portion 400 coupled with the reservoir body 300, fixing the fuel pump 310, and having a fuel outlet hole 410 via which fuel pumped by the fuel pump 310 is ejected; and a fuel pump tube 500 connecting the insert port 130 and the fuel outlet hole 410, wherein one side of the insert port 130 is coupled with the inner side of the inlet port 120, and the other side of the insert port 130 is connected to the fuel pump tube 500, and wherein the insert port 130, the pump mounting portion 400 and the fuel pump tube 500 are made of electrically conductive material, so that the pump mounting portion 400 is electrically connected to a connector 140 formed on the flange assembly 100 by a ground lead line 600.

At first, the flange assembly 100 includes the flange 110, the inlet port 120 and the insert port 130. The flange 110 has the inlet port 120 protruding from the upper side of the flange 110 so as to supply fuel sucked from a fuel tank to an engine side, and a fuel supplying line is connected to the inlet port 120 to pump the fuel to the engine. Further, the insert port 130 is formed at the lower side of the flange 110 to connect the inlet port 120 to the flange 110.

The guide rod 200 extends from the lower side of the flange assembly 100, and may include elastic means 210 into which the guide rod 200 is inserted.

The reservoir body 300 is couple with the guide rod 200, and includes the fuel pump 310 therein. Here, the reservoir body 300 is supported by the elastic means 210 into which the guide rod 200 is inserted, so that distance between the flange assembly 100 and the reservoir body 300 may be adjustable when they are pressed from both sides. Further, a void section is formed at the lower side of the reservoir body 300 through which fuel flows in, so that fuel in the fuel tank is sucked by the fuel pump 310 mounted in the reservoir body 300 to fill the reservoir body 300, and the fuel pump 310 sucks the fuel filled in the reservoir body 300 and in the fuel tank to eject it to the engine.

The pump mounting portion 400 is coupled at the upper side of the reservoir body 300, and the fuel pump 310 is fixed to the pump mounting portion 400. Further, the pump mounting portion 400 has the fuel outlet hole 410 at its upper side, and is coupled with the fuel pump 310 so that the fuel pumped out from the fuel pump 310 is ejected through the fuel outlet hole 410 of the pump mounting portion 400. In the reservoir body 300, an in-tank filter coupled with the pump mounting portion 400 is provided, such that the fuel pumped out from the fuel pump 310 is filtered through the in-tank filter and then ejected through the fuel outlet hole 410 of the pump mounting portion 400.

The fuel pump tube 500 has one end connected to the insert port 130 of the flange assembly 100 and the other end connected to the fuel outlet hole 410 of the pump mounting portion 400.

By doing so, the fuel sucked and pumped out by the fuel pump 310 is supplied to the engine side flowing through the fuel outlet hole 410, the fuel pump tube 500, the insert port 130, and the inlet port 120.

In addition, the insert port 130 is coupled with inner side of the inlet port 120 on one side, and is connected to the fuel pump tube 500 on the other side. As shown in FIG. 3, the insert port 130 may be formed so that it is coupled with only a part of the inner side of the inlet port 120. That is, the flange 110 and the inlet port 120 are integrally formed and one side of the insert port 130 is inserted into the inner side of the inlet port 120.

In addition, the insert port 130, the pump mounting portion 400 and the fuel pump tube 500 are formed of electrically conductive materials, and the pump mounting portion 400 is electrically connected to the connector 140 formed in the flange assembly 100 by the ground lead line 600. That is, the pump mounting portion 400, the fuel pump tube 500 and the insert port 130, which are in contact with the fuel pumped out by the fuel pump and flowing, are all made of electrically conductive materials so that they conduct electricity among them. Here, one end of the ground lead line 600 is connected to the pump mounting portion 400 and the other end is connected to the connector 140, so that the static electricity generated in the pump mounting portion 400, the fuel pump tube 500 and the insert port 130, which are in contact with the fuel flowing portion, may be discharged to the outside through the connector 140 formed on the flange assembly 100.

As such, in the fuel pump module according to the embodiment of the present invention, the lines from the pump mounting portion where the fuel pump is mounted to the inlet port of the flange assembly are made of electrically conductive materials and are connected to the connector formed on the flange assembly by the ground lead line, so that the static electricity generated by the friction caused by the flow of the fuel is discharged to the outside of the fuel pump module, i.e., the chassis of a vehicle, thereby preventing the static electricity from accumulating on the fuel pump module. Consequently, firing and explosion due to the static electricity can be prevented.

Further, the insert port 130 may be formed integrally with the flange 110 and the inlet port 120 by insert injection molding. That is, the insert port 130 may be first formed, and then the flange 110 and the inlet port 120 may be integrally formed by insert injection molding.

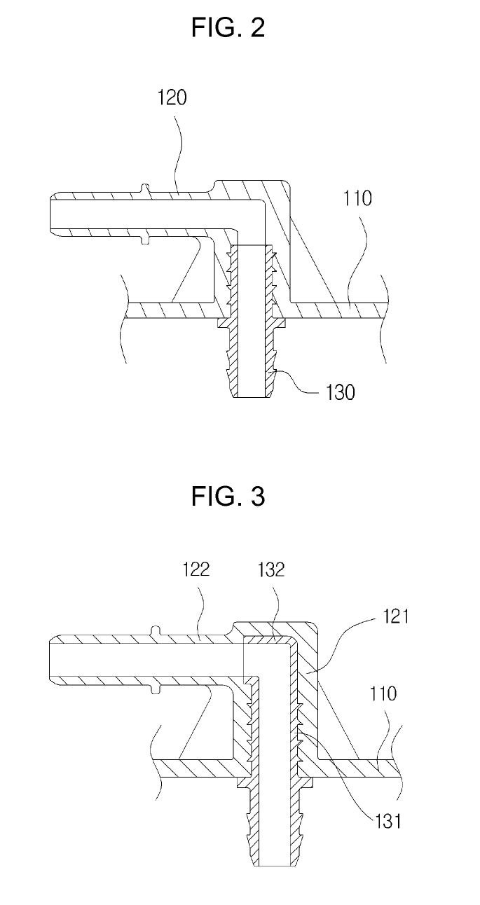

Accordingly, as shown in FIG. 2, the flange 110 and the inlet port 120 are integrally formed and one side of the insert port 130 is inserted into the inner side of the inlet port 120, such that fuel does not leak into the portion where the flange 110 and the inlet port 120 are coupled with each other, and the fuel flowing into the insert port 130 to eject through the inlet port 120 does not leak either. Additionally, the flange 110 and the inlet port 120 are integrally formed so that the strength is enhanced, and the possibilities of cracks around the inlet port 120 or fuel leakage may be lowered which may occur when a connection hose into which the inlet port 120 is inserted or the like is assembled or a vehicle vibrates.

Further, the insert port 130 made of electrically conductive material has lower strength due to the material's nature. Accordingly, the insert port 130 is formed only at a part of the inner side of the inlet port 120, such that static electricity may be prevented from being accumulated at the insert port 130 while the strength of the inlet port 120 is not lowered.

Further, the inlet port 120 is extended from the upper side of the flange 110 and bent toward one side, and one side of the insert port 130 is coupled with the inner side of the inlet port 120. The insert port 130 may be coupled to include the bent portion of the inlet port 120.

That is, the inlet port 120 includes a vertical portion 121 which is extended from the upper side of the flange 110 and a horizontal portion 122 which is bent and extended from the vertical portion 121, and one side of the insert port 130 includes a vertical portion 131 and a horizontal portion 132 so as to be coupled with the inner side of the inlet port 120, the insert port 130 being formed even at the bent portion of the inlet port 120.

This is for minimizing reduction in strength of the inlet port 120 since the insert port 130 is formed of electrically conductive material, and for easily forming the flange 110 and the inlet port 120 integrally by insert injection molding after the insert port 130 is manufactured. That is, referring to FIG. 3, when the insert port 130 is fixed and the flange 110 and the inlet port 120 are integrally injected, since the mold core inserted into the channel formed inside the inlet port 120 only needs to be formed to the end of the horizontal portion 132 of the insert port 130, the manufacturing of the mold core and the insert injection may become easy. In addition, the insert port 130 may include the bent portion of the inlet port 120, such that static electricity possibly occurring when fuel passes through the bent portion may be effectively discharged.

Further, the other side of the insert port 130 may be formed with a slope with respect to the normal direction of the surface of the flange 110.

That is, as shown in FIG. 4, the other side of the insert port 130, which protrudes from the lower surface of the flange 110, is formed with a certain degree of slope with respect to the normal direction of the lower surface of the flange 110. By doing so, the fuel pump tube 500 may be inclined, thereby reducing the distance between the flange assembly 100 and the pump mounting portion 400 and thus the overall height of the fuel pump module. Thus, the fuel pump module according to the embodiments of the present invention may be easily applied to a fuel tank with a lower height.

Alternatively, the horizontal portion 122 of the inlet port 120 is extended from one side of a protruding portion 123 protruding upwardly of the flange 110, and a recessed hollow portion 124 is formed at the lower side of the protruding portion 123, such that one side of the insert port 130 is coupled with the protruding portion 123 of the inlet port 120, and the other side of the insert port 130 may be located at the recessed hollow portion 124.

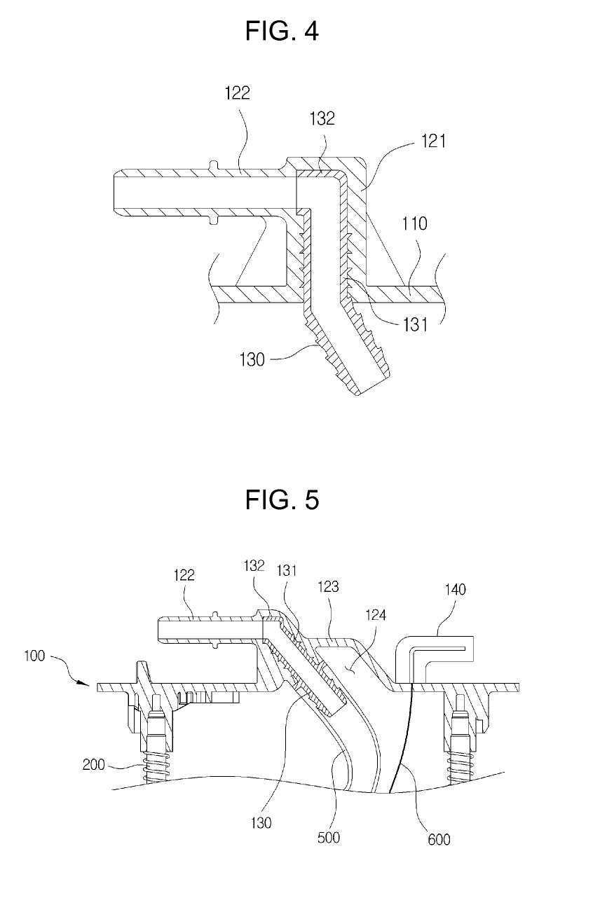

That is, as shown in FIG. 5, the inlet port 120 protrudes from the upper side of the flange 110, the horizontal portion 122 is extended in the horizontal direction from the one side of the protrusion portion 123, and the recessed hollow portion 124 is formed at the lower side of the protruding portion 123. Accordingly, the lower side of the recessed hollow portion 124 is opened, one side of the insert port 130 is coupled with the protruding portion 123 of the inlet port 120 to be connected to the inlet port 120, and the other side protrudes to be located at the recessed hollow portion 124.

By doing so, the height between the flange assembly 100 and the pump mounting portion 400 may be reduced, and thus the overall height of the fuel pump module may be reduced. Further, by forming the protruding other side of the insert port 130 in the recessed hollow portion 124 so as not to protrude from the lower surface of the flange's lower surface, the breakage of the insert port 130 may be prevented.

Further, one side of the insert port 130 may be coupled with a part of the horizontal portion 122 of the inlet port 120 and the protruding portion 123, and the other side of the insert port 130 may be located at the recessed hollow portion 124.

That is, like in the previous embodiment in which the horizontal portion 132 is formed at one side of the insert port 130 and the horizontal portion 132 of the insert port 130 is coupled with a part of the horizontal portion 122 of the inlet port 120, reduction in strength of the inlet port 120 due to the insert port 130 formed of low-strength, electrically conductive material, may be minimized. In addition, when the insert port 130 is fixed and the flange 110 and the inlet port 120 are integrally injected, the mold core inserted into the channel formed inside the inlet port 120 only needs to be formed to the end of the horizontal portion 132 of the insert port 130, so that the mold core may be easily manufactured and injected.

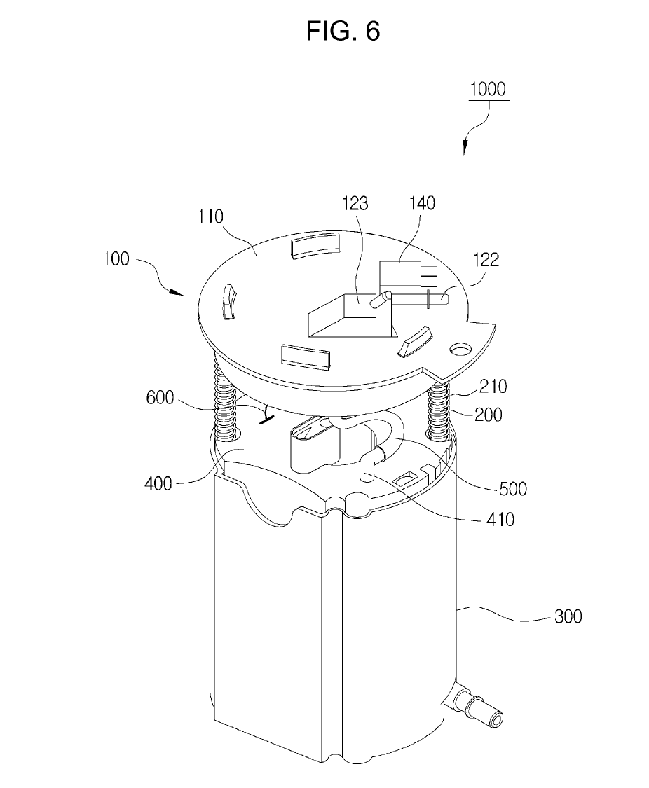

Further, the other side of the insert port 130 may be formed with a slope with respect to the normal direction of the surface of the flange 110. That is, as shown in FIGS. 5 and 6, the vertical portion 131 of the insert port 130 and the protruding other side are formed with a certain degree of slope with respect to the normal direction of the lower surface of the flange 110. By doing so, the fuel pump tube 500 may be fixed with a slope, thereby reducing the distance between the flange assembly 100 and the pump mounting portion 400 and thus the overall height of the fuel pump module. Here, the right side of the recessed hollow portion 124 may be also inclined so that the insert port 130 may be easily inserted into the fuel pump tube 500.

The inner diameter of the insert port 130 may be equal to that of the inlet port 120 so that fuel may flow smoothly. At the outer circumferential surfaces of the ends of the inlet port 120 and the insert port 130, projections may be formed so as to prevent a hose connected from falling out.

In addition, by forming bumps or projections on the outer circumferential surfaces of one side of the insert port 130 to be coupled with the inlet port 120, when the flange 110 and the inlet port 120 are integrally manufactured by insert injection, the coupling force among the flange 110, the inlet port 120 and the insert port 130 is enhanced, thereby preventing fuel from leaking.

As stated above, in the fuel pump module according to the embodiment of the present invention, the lines from the pump mounting portion where the fuel pump is mounted to the inlet port of the flange assembly are made of electrically conductive materials and are connected to the connector formed on the flange assembly by the ground lead line, so that the static electricity generated by the friction caused by the flow of the fuel is discharged to the outside of the fuel pump module, i.e., the chassis of a vehicle, thereby preventing the static electricity from accumulating on the fuel pump module. Consequently, firing and explosion due to the static electricity can be prevented.

Further, inside of an inlet port integrally formed with a flange assembly, an insert port of conductive material is inserted or is integrally formed by inset injection molding, such that it is possible to prevent fuel from leaking around the inlet port which is outside of the flange assembly.

The present invention is not limited to the above-mentioned exemplary embodiments but may be variously applied, and may be variously modified by those skilled in the art to which the present invention pertains without departing from the gist of the present invention claimed in the claims.

What is claimed is:

1. A fuel pump module, comprising:
a flange assembly in which a inlet port is formed at one side of a flange and an insert port connected to the inlet port is formed at the other side;
a guide rod extending from the flange assembly;
a reservoir body coupled with the guide rod and having a fuel pump therein;
a pump mounting portion coupled with the reservoir body, fixing the fuel pump, and having a fuel outlet hole via which fuel pumped by the fuel pump is ejected; and
a fuel pump tube connecting the insert port and the fuel outlet hole,
wherein the flange of the flange assembly and the inlet port are integrally formed, one side of the insert port being inserted into the inlet port, and the other side of the insert port being connected to the fuel pump tube, and
wherein the insert port, the pump mounting portion and the fuel pump tube are made of electrically conductive material, so that the pump mounting portion is electrically connected to a connector formed on the flange assembly 100 by a ground lead line.

2. The fuel pump module of claim 1, wherein the inlet port is extended from the upper side of the flange and bent toward one side, and one side of the insert port is coupled with inner side of the inlet port, wherein the insert port is coupled to include the bent portion of the inlet port.

3. The fuel pump module of claim 1, wherein the other side of the insert port is formed with a slope with respect to the normal direction of the surface of the flange.

4. The fuel pump module of claim 1, wherein the horizontal portion of the inlet port is extended from one side of a protruding portion protruding upwardly of the flange, a recessed hollow portion being formed at the lower side of the protruding portion, and
wherein one side of the insert port is coupled with the protruding portion of the inlet port, and the other side of the insert port is located at the recessed hollow portion.

5. The fuel pump module of claim 4, wherein one side of the insert port is coupled with a part of the horizontal portion of the inlet port and the protruding portion, and the other side of the insert port is located at the recessed hollow portion.

6. The fuel pump module of claim 4, wherein the other side of the insert port is formed with a slope with respect to the normal direction of the surface of the flange.

7. The fuel pump module of claim 1, wherein the insert port is formed integrally with the flange and the inlet port by insert injection molding.
